(19) United States
(12) Patent Application Publication
(10) Pub. No.: US 2018/0369919 A1
(43) Pub. Date: Dec. 27, 2018

(54) COMPOSITE MATERIAL, METHOD FOR THE PRODUCTION OF A COMPOSITE MATERIAL, AND A DISCHARGE COMPONENT INCLUDING A COMPOSITE MATERIAL

(71) Applicant: OBE OHNMACHT & BAUMGÄRTNER GMBH & CO. KG, Ispringen (DE)

(72) Inventor: Carlo BURKHARDT, Engelsbrand (DE)

(73) Assignee: OBE OHNMACHT & BAUMGÄRTNER GMBH & CO. KG, Ispringen (DE)

(21) Appl. No.: 16/061,167

(22) PCT Filed: Dec. 14, 2016
(86) PCT No.: PCT/EP2016/081026

§ 371 Date: Jun. 11, 2018

(30) Foreign Application Priority Data
Dec. 15, 2015 (DE) 10 2015 225 302.3

(51) Int. Cl. B22F 3/20; B22F 3/22; B22F 1/00; H01T 13/39; H01T 19/00

(52) U.S. Cl. CPC B22F 3/20; B22F 3/225; B22F 3/227; B22F 1/0014; B22F 1/0059; B22F 2998/10; H01T 19/00; B22F 2301/15; B22F 2301/25; B22F 2301/35; H01T 13/39

(57) ABSTRACT

A composite material includes a first metallic material component and a second metallic material component. The first material component is different from the second material component. The second material component is mixed with the first material component.

The invention relates to a composite material, a method for producing such a composite material and a discharge component comprising such a composite material.

Discharge components, which are typically embodied as electrodes or may be arranged on electrodes, are used to induce a discharge, for example, a sparkover, between the discharge component and a counter electrode. Because of the high electrical voltages applied directly before the discharge, the high electrical currents flowing during the discharge and the high temperatures prevailing during a discharge, erosion may occur and corrosion of the discharge components may also occur—in particular when the discharge occurs in a corrosive atmosphere. It is fundamentally possible to provide a multilayer discharge component, having a base metal layer consisting of a less noble metal and a noble metal layer of a more noble metal, wherein the noble metal layer is arranged in a layer on the base metal layer. The discharge component may then be used in such a way that a discharge occurs in the area of the noble layer, which is more stable with respect to both erosion and corrosion than the base metal layer. At the same time, the base metal layer is protected by the noble metal layer. However, such a multilayer discharge component is less flexible with regard to its geometric design and also requires a comparatively large amount of the more noble metal, so that it is expensive both to use and to manufacture.

The invention is based on the object of creating a composite material, a method for producing a composite material and a discharge component having such a composite material, while avoiding the aforementioned disadvantages.

This object is achieved by creating the subject matters of the independent claims. Advantageous embodiments are derived from the dependent claims.

This object is achieved in particular by creating a composite material, comprising a first metallic material component and a second metallic material component. The first material component is different from the second material component, wherein the first material component, for example, may have a lower melting point than the second material component. It is provided here that the second material component, in a particulate form in particular, preferably in the form of crystalline particles—is mixed with the first material component, preferably being incorporated into the first material component. Such a material is particularly suitable for use for a corrosion-resistant and erosion-resistant discharge component, wherein it is possible in particular—most especially in comparison with a layered structure—to save on the material of the second material component. This makes the composite material inexpensive. On the whole, a larger effective area for the discharge in the region of the second material component due to the distribution of the second material component in the first material component, so the result is a local reduction in wear. The second material component, which preferably has a higher-melting point, preferably also has a higher specific conductance than the first material component, which preferably has a lower melting point, so that discharges preferably start in the region of the second material component, but they seek a discharge path over the first material component. Therefore, wear on the first material component drops on the whole. In addition, it is found that the discharge components typically show signs of wear after a burn-off of approx. 200 μm—measured from the original surface in the direction of depth—so they must be discarded and replaced. By using this composite material, it is possible to save on expensive material because a smaller amount of the material of the second material component, which is typically more expensive, is typically used with such a combination or incorporation than would be the case if it were provided in the form of a coating on the first material component, for example, or if the discharge component were formed completely from the material of the second material component. If erosion of the discharge component occurs, then the lower-melting material of the first material component will erode first in particular, the material of the second material component being preserved in particular in the form of particles at the surface of the discharge component, as long as these particles are adequately supported by the material of the first material component. If the material of the first material component is eroded to such an extent that the particles are no longer held, then they fall out of the first material component, wherein the particles of the second material component behind them are exposed at the same time and replace the particles that have fallen out at the front.

The term “discharge component” is understood here in particular to refer to a device or a part of a device that is equipped and is provided as intended to be the starting point for an electrical discharge, in particular to a counter electrode. Such a discharge component may be, for example, a part of an electrode or arranged on an electrode or may itself be designed as an electrode. It is possible in particular for the discharge component to be designed as a tip, in particular an ignition tip of an electrode.

The term “discharge” is understood here in particular to refer to a spark discharge or a sparkover, a plasma discharge, a dielectric barrier discharge or a “silent” electric discharge, a corona discharge or an arc discharge. The discharge may be created by means of a direct voltage as well as by means of an alternating voltage. The discharge component may be embodied in particular as a spark discharge component.

A composite material is understood here in general to refer to a material comprising at least two different materials, preferably materials that are joined together in a form-fitting and/or force-locking and/or physically bonded manner, such that the two different materials are preferably present in different regions that can be differentiated from one another spatially. They are thus preferably present side-by-side in the composite material.

A material component is understood here in particular to refer to a material covered by the term “composite” material. The material component may be a pure material, in particular a chemical element or a compound, in particular a covalent compound, an ionic compound, a complex compound, a metallic compound and/or an alloy.

The term “melting point” is understood here to refer not only to a point on the temperature scale—which is generally known exactly only for pure substances—as well as a melting range, such as that which may be characteristic of material components in particular, which comprise a plurality of different substances.

The fact that the second material component is mixed with the first material component means in particular that the first material component and the second material component are present side-by-side in the composite material. In particular it is possible that particles—preferably crystalline—of the second material component are present in addition to particles —preferably crystalline—of the first material component. It is also possible that particles of a material component, selected from the first and second material components are distributed in a partially or completely cohesive material (matrix) of the other material component, selected from the second material component and the first material component. The composite material may thus be a mix or an incorporating material. A mixed form consisting of a mix and an incorporating material is also possible. Paths of contacting particles of the same one or two material components may also be present in the composite material for one of the material components or for both material components. It is possible for the particles of the first and second material components forming the mixture to be present in a somewhat uniform distribution in the composite material.

According to a refinement of the invention, it is preferably provided that the second material component—preferably in particle form—is incorporated into the first material component. This means in particular that the second material component forms definable domains in the first material component, i.e., spatial regions, which are enclosed by the first material component in at least some areas, wherein the second material component is located in these domains or spatial regions. These domains or regions are then free of the first material component in particular and preferably contain only the second material component.

According to a preferred embodiment of the composite material, the second material component is in homogenous distribution in the first material component. This yields a uniform spatial distribution of the second material component in the first material component, preferably at least on the average. However, it is also possible for the second material component to be in a heterogeneous distribution in the first material component, wherein regions may be provided in particular, in which the particles of the second material component are present in a greater numerical density than in other regions.

According to a refinement of the invention, it is provided that the first material component forms a cohesive matrix, into which the second material component is incorporated in particulate form. The term “cohesive” here means in particular that the first material component is not present in the form of separate closed domains or regions but that the regions of the first material component are connected to one another in particular by webs, bridges or other spatial characteristics of the first material component. In this way, the first material component forms a matrix in which the second material component is incorporated in particulate form, similar to embedding raisins in cake batter, for example. The composite material may therefore be interpreted as a metal matrix composite material consisting of a cohesive low-melting metal matrix, into which a higher-melting material, namely the second material component, is incorporated.

According to one refinement of the invention, it is provided that the second material component is incorporated discontinuously into the first material component. This means in particular that regions or domains of the second material component do not have any contact with one another, in particular thus being arranged separately from one another and in particular not coming in contact with one another. The second material component is preferably incorporated into the first material component in the form of separate particles. The individual particles are preferably completely surrounded by the first material component or they are in contact with an outer environment of same—in marginal regions of the composite material—but are not in contact with other particles of the second material component. This is advantageous because a comparatively low numerical density of particles of the second material component can be ensured in this way, so the composite material can be produced inexpensively.

Embedding the second material component in the cohesive matrix of the first material component has the advantage in particular that heating, such as that which occurs during operation of a discharge component, for example, causes the matrix material of the first material component to expand to a greater extent than the incorporated material of the second material component, so that the particles of the second material component are solidified in the matrix of the first material component. In contrast with a layer structure, in which different thermal expansion coefficients result in erosion of the material, a greater expansion of the matrix material here thus results in a more secure hold of the incorporated particles of the second material component in the matrix.

It has been found that the first material component, which preferably has the lower melting point, preferably also has a greater thermal expansion coefficient than the second material component, which preferably has the higher melting point.

It is also possible that the first material component is incorporated into or embedded in the second material component. According to one refinement of the invention, it is thus provided that the first material component has a lower melting point than the second material component.

Additionally or alternatively, it is preferably provided that the second material component is more noble than the first material component. In this way, the second material component is at the same time more stable than the first material component with respect to erosion and corrosion, in particular in use of the composite material for a discharge component. The term “more noble” here is understood in particular to mean that the second material component has a higher standard potential than the first material component. A standard potential is understood in particular to refer to the standard potential of a redox pair of the respective material component, namely the electrical voltage that can be measured between a hydrogen half-cell and a half-cell of this redox pair under standard conditions. It is true here that the more positive the standard potential—i.e., the higher it is—the more noble is the corresponding material component. The second material component preferably has a standard potential that is higher than zero, wherein it is more noble than hydrogen, for which the standard potential is zero by definition. The first material component preferably also has a standard potential higher than zero. The standard potential of the second material component is preferably higher than the standard potential of the first material component. It is possible that the first material component has a standard potential lower than zero. Again in this case, the second material component preferably has a standard potential higher than zero.

It is possible in particular that the first material component is a non-noble metal or a non-noble metal alloy, wherein the second material component is a noble metal or a noble metal alloy.

According to one refinement of the invention, it is provided that the first material component is a nickel-based alloy or consists of a nickel-based alloy. The term “nickel-based alloy” is understood in particular to refer to an alloy, whose main component is nickel, and the alloy contains at least one additional chemical element. The nickel-based alloy is preferably produced by means of a melting method. A nickel-based alloy has a good corrosion resistance and/or a high temperature resistance. It is also relatively inexpensive at the same time.

Alternatively, it is possible for the first material component to comprise a malleable iron alloy, in particular steel, or to consist of a malleable iron alloy, in particular steel. The first material component preferably comprises stainless steel or consists of stainless steel. Malleable iron alloys, in particular steels and most especially stainless steel may have favorable corrosion resistance and/or high temperature resistance, while at the same time being inexpensive.

According to one refinement of the invention, it is provided that the first material component comprises or consists of an alloy, comprising nickel as its main component, and chromium as at least one additional chemical element. In particular, the alloy preferably comprises nickel as the main component and chromium as the most important secondary component, i.e., in particular the most common secondary component in terms of percent by weight. Such alloys are also known by the designation “Inconel.” They are suitable in particular for high-temperature applications and are suitable for production of discharge components in particular. In addition, they are resistant to corrosion, so they are also suitable for applications and extreme environments. When heated, a stable oxide layer is formed, protecting the surface. The strength is maintained over a wide temperature range. Such alloys are superior to aluminum in particular as well as certain steels.

The first material component preferably contains, in addition to nickel and chromium, at least one element selected from a group consisting of iron, molybdenum, niobium, cobalt, manganese, copper, aluminum, titanium, silicone, carbon, nitrogen, sulfur, phosphorus, tantalum and boron.

According to one exemplary embodiment of the composite material, it is provided that the first material component has the following composition—all values given in percent by weight:
Nickel at least 72;
Chromium at least 14 up to at most 17;
Iron at least 6 up to at most 10;
Cobalt at most 1;
Carbon at most 0.15;
Manganese at most 1;
Sulfur at most 0.25;
Silicon at most 0.5;
Copper at most 0.5;
Phosphorus at most 0.2;
Titanium at most 0.3;
Aluminum at most 0.3;
Boron at most 0.006.

Remainder: impurities, depending on the manufacturing process. The first material component is preferably Inconel 600 or Nicrofer 7216H or has material no. 2.4816.

According to another exemplary embodiment of the composite material, it is provided that the first material component has the following composition—all values in percent by weight:
Nickel at least 58 up to at most 63;
Chromium at least 21 up to at most 25;
Aluminum at least 1 up to at most 1.7;
Carbon at most 0.1;
Manganese at most 1.5;
Cobalt at most 1.5;
Sulfur at most 0.015;
Phosphorus at most 0.02;
Silicon at most 0.5;
Copper at most 1.0;
Titanium at most 0.5;
Boron at most 0.006.

Remainder: iron and impurities, depending on the production process. The first material component is preferably Inconel 601 or has material no. 2.4851.

According to an additional exemplary embodiment of the composite material, the first material component has the following composition—all values given in percent by weight:
Nickel at least 58;
Chromium at least 20 up to at most 23;
Molybdenum at least 8 up to at most 10;
Niobium at least 3.15 up to at most 4.15;
Iron at most 5;
Cobalt at most 1;
Copper at most 0.5;
Silicon at most 0.5;
Manganese at most 0.5;
Aluminum at most 0.4;
Titanium at most 0.4;
Carbon at most 0.1;
Phosphorus at most 0.02;
Sulfur at most 0.015;
Nitrogen at most 0.02.

Remainder: impurities, depending on the manufacturing process. The first material component preferably has the same amount of niobium and tantalum—in percent by weight—of at least 3.15 to at most 4.15. The first material component is preferably Inconel 625 or has material no. 2.4856.

According to another exemplary embodiment of the composite material, the first material component has the following composition—all values in percent by weight:
Nickel at least 50 up to at most 55;
Chromium at least 17 up to at most 21;
Molybdenum at least 2.8 up to at most 3.3;
Niobium (+tantalum) at least 4.75 up to at most 5.5;
Titanium at least 0.65 up to at most 1.15;
Aluminum at least 0.2 up to at most 0.8;
Cobalt at most 1;
Carbon at most 0.08;
Manganese at most 0.35;
Silicon at most 0.35;
Phosphorus at most 0.015;
Sulfur at most 0.015;
Boron at most 0.006;
Copper at most 0.3.

Remainder: iron and impurities, depending on the manufacturing process. The first material component is preferably Inconel 718 or has material no. 2.4668.

According to another exemplary embodiment of the composite material, the first material component has the following composition—all values given in percent by weight:
Chromium at least 16 up to at most 18.5;
Nickel at least 10 up to at most 15;
Molybdenum at least 2 up to at most 3;
Carbon at most 0.035;
Silicon at most 1;
Manganese at most 2;
Phosphorus at most 0.045;
Sulfur at most 0.03;
Nitrogen at most 0.11.

Remainder: iron and impurities, depending on the manufacturing process. The first material component is preferably a stainless steel with the designation X2CrNiMo17-12-2 or it has material no. 1.4404.

According to another exemplary embodiment of the composite material, the first material component has the following composition—all values given in percent by weight:
Chromium at least 19 up to at most 24;
Nickel at least 11 up to at most 15;
Carbon at most 0.2;
Silicon at most 2.5;
Manganese at most 2;
Phosphorus at most 0.045;
Sulfur at most 0.03;
Nitrogen at most 0.11.

Remainder: iron and impurities, depending on the manufacturing process. According to a preferred embodiment, it is provided that the first material component comprises silicon in an amount—in percent by weight—of at least 1.5 to at most 2.5. The first material component is preferably a heat-resistant steel with the designation X15CrNiSi20-12 or has the material no. 1.4828.

According to one refinement of the invention, it is provided that the second material component is an element selected from the group consisting of iridium, platinum, rhodium, ruthenium, palladium and a metal of the rare earth group.

A metal of the rare earth group, which is also referred to as a rare earth metal, is understood in particular to be a chemical element, also in the form of a compound, and in particular an alloy with at least one other chemical element belonging to the chemical group of rare earths. These include in particular the chemical elements of the third subgroup of the periodic system, except for actinium and the lanthanoids. The rare earth metal is preferably selected from a group consisting of scandium, lanthanum, cerium, praseodymium, neodymium, promethium, samarium, europium, yttrium, gadolinium, terbium, dysprosium, holmium, erbium, thulium, ytterbium and lutetium. The rare earth metal is preferably selected from the so-called light rare earth elements, namely a group consisting of scandium, lanthanum, cerium, praseodymium, neodymium, promethium, samarium and europium. Alternatively or additionally, the rare earth metal is preferably selected from the group of so-called heavy rare earth elements, namely a group consisting of yttrium, gadolinium, terbium, dysprosium, holmium, erbium, thulium, ytterbium and lutetium.

The second material component preferably consists of one of these elements. The elements may be present in pure form but they may also be present in bound, alloyed or combined or alloyed form. It is possible in particular for the second material component to contain, in addition to at least one of the elements listed here, impurities depending on the manufacturing process. The second material component preferably comprises an alloy containing platinum and iridium or iridium and rhodium, preferably platinum-iridium or iridium-rhodium. The second material component preferably consists of such an alloy. The second material component preferably comprises—or consists of—an iridium alloy, which preferably consists of iridium, wherein it preferably comprises at least 95 percent by weight iridium. The elements and/or alloys listed here have very high melting points of more than 1500° C. and are also both heat resistant and corrosion resistant. In particular the materials listed here for the second material component are preferably more corrosion resistant, in particular more noble, than the materials listed for the first material component above. The materials listed for the second material component are also more expensive than the materials listed for the first material component. Therefore, the composite material can be embodied inexpensively if it comprises the second material component—in particular in particulate form—incorporated into the first material component.

The second material component may in particular comprise smaller amounts of one or more non-noble metals, in particular those from the secondary groups 3B and 4B of the periodic system of elements, for example, zirconium, titanium, hafnium and yttrium.

According to a refinement of the invention it is preferably provided that the amount of the second material component of the composite material—in percent by weight—amounts to at most 80, preferably at most 70, preferably at most 60, preferably at most 50, preferably at most 40, preferably at most 30, preferably at least 10 to at most 30, preferably at most 20, preferably at most 10. It has been found here that favorable properties with regard to the erosion resistance and corrosion resistance of the composite material can be achieved even with relatively low amounts by weight of the second material component, wherein the composite material is less expensive as the amount of the second material component is lower.

Additionally or alternatively, it is preferably provided that the volume ratio of the second material component to the first material component amounts to at least 10:90 to at most 90:10, in particular at least 30:70 to at most 60:40, in particular 50:50. The volume amount of the second material component may be in particular at least 10 vol % to at most 90 vol %, preferably at least 20 vol % to at most 80 vol %, preferably at least 30 vol % to at most 70 vol %, preferably at least 40 vol % to at most 60 vol %, preferably 50 vol %.

According to a refinement of the invention, it is provided that the second material component is present in the form of particles, preferably in the form of particles incorporated into the first material component, wherein the particles have a particle size of at least 5 μm to at most 100 μm, preferably to at most 70 μm, preferably to at most 50 μm, preferably from at least 10 μm to at most 30 μm, preferably from at least 10 μm to at most 20 μm, preferably from at least 15 μm to at most 25 μm. This particle size range ensures good functioning of a discharge component manufactured with the composite material, wherein particles of the second material component in particular, released from the composite material at the same time, do not interfere with operation of a device having the discharge component. The particles may in particular be readily discharged through a coolant and/or lubricant. The smaller the particles at the same amount of the second material component in the composite material, the more particles the composite material will have. The advantage of a larger number of particles is in turn that, in the event of wear on the composite material, more particles will reach the interface or a burnoff zone more quickly. In addition, this results in more possible sites for the start of discharges on a surface of the composite material.

“Particle size” here is understood in particular to refer to the equivalent diameter of particles. In particular the term “particle size” is understood to refer to a geometric-equivalent diameter, in particular a volume-equivalent diameter of a sphere or a surface-equivalent diameter of a sphere. A geometric-equivalent diameter of an irregularly shaped particle is obtained in particular in that the diameter of an imaginary sphere having the same volume (volume-equivalent) or the same surface (surface-equivalent) as the irregularly shaped particle is determined.

In addition, the term “particle size” is understood in particular to refer to an average value of an equivalent diameter distribution. Such an average particle size can be determined according to the linear intercept method, for example.

The particle size of the particles of the second material component may be smaller, the same size or larger than the particle size of particles of the first material component.

This object is also achieved in particular in that a method for producing a composite material is created, in particular a composite material according to any one of the exemplary embodiments described above, wherein the method comprises the following steps: a first powdered metallic material component is mixed with a second powdered metallic material component, wherein the first material component and the second material component are different from one another, and wherein the first material component preferably has a lower melting point and/or is less noble than the second material component. This yields a mixture comprising the first material component and the second material component. A mixture is also understood in particular to be a blend. The mixture is shaped to form a molded body, and the molded body is sintered at a sintering temperature that is preferably lower than the melting point of the second material component. In conjunction with this method, the advantages already explained in conjunction with the composite material are implemented in particular. If the sintering temperature is lower than the melting point of the second material component, the latter component is not melted during sintering but instead is incorporated into the first material component if the first material component has a lower melting point than the second material component. In particular this then yields particulate incorporation of the second material component, which is preferably in the form of a granular powder, into a matrix formed from the first material component during sintering. In particular this forms a cohesive matrix of the first material component, into which the second material component is incorporated in the form of particles.

According to a refinement of the invention, it is proposed that a binder component is added to and mixed with the first and/or second material component(s). A mixture comprising the first material component, the second material component and the binder component is obtained in this case.

Mixing the binder component with the first and/or second material component(s) and/or mixing the first material component with the second material component preferably take(s) place in an attritor, a kneading mixer, a powder mixer or an extruder. This results in the most uniform, homogenous possible distribution of the various components.

The mixture is preferably prepared as a free-flowing powder, as a kneadable mass or as an injectable mass. The embodiment of the mixture can be adjusted in particular by omitting or specifically selecting the binder component—preferably an organic component.

According to one embodiment of the method, it is provided that the first material component and the second material component are mixed together first, and then a binder component is blended into the mixture prepared in this way.

According to another embodiment of the method, it is provided that the first material component is mixed first with a binder component, then the second material component is mixed into that. It is also possible for the second material component to be mixed initially with a binder component, and then for the first material component to be mixed into that. Finally, it is also possible for the first material component to be mixed initially separately with a binder component and for the second material component to be mixed with a binder component, so that the mixtures prepared separately in this way are then mixed together.

Additional components, in particular additional alloy components and/or additives are preferably mixed in, wherein this can take place by mixing these components into the separate first powdered material component, the separate second powdered material component and/or a mixture of the first and second powdered material components—each optionally enriched by a binder component.

The method preferably also comprises the production of a powder of the first material component and/or the second material component. In doing so, the resulting particle size for the particles of the second material component to be incorporated into the first material component is preferably adjusted in particular in production of the powder of the second material component.

Since the sintering temperature is preferably selected to be lower than the melting point of the second material component, the latter is then not melted, so that the particle size preferably adjusted in the production of the powder is also maintained in the finished composite material.

By weighing the various components, it is possible to adjust the composition of the mixture and thus ultimately also the composition of the resulting composite material. The second material component is preferably added in an amount—based on the finished composite material—of at most 80—in percent by weight—preferably at most 70, preferably at most 60, preferably at most 50, preferably at most 40, preferably at most 30, preferably at most 20, preferably at most 10 and/or in a volume ratio of at least 10:90 to at most 90:10, in particular at least 30:70 to at most 60:40, in particular 50:50.

Reference to the finished composite material is appropriate inasmuch as the binder component that is optionally present is preferably removed during sintering at the latest, wherein a thermal removal of binder preferably takes place then at the latest. However, it is also possible for a binder removal step, in which the binder component is removed, to take place before sintering.

The fact that the mixture is shaped to form a molded body means in particular that a certain spatial geometric shape is imparted to the mixture. Before being shaped to form a molded body, the mixture is preferably in the form of a loose packing, in particular a free-flowing powder, a kneadable mass or an injectable mass, and to this extent does not have a certain shape. A certain spatial shape is imparted to the mixture, preferably corresponding essentially to a final shape desired for the composite material at least approximately—in particular except for any shrinkage that typically occurs in sintering.

A molded body is thus understood in particular to refer to a body having a certain spatial geometric shape.

It is possible for the molded body to be mechanically reprocessed prior to sintering. In particular it is possible for the molded body to be reshaped by cutting and grinding. The shape of the molded body can be approximated even more closely to the desired final shape of the composite material in this way.

The molded body is also referred to as a green body or greenware.

According to a refinement of the invention, it is provided that the sintering temperature is chosen to be hot enough that the powdered first material component is sintered, wherein the individual powder grains of the first material component are bonded to one another physically in particular by diffusion processes. It is possible for the sintering temperature to be chosen to be high enough that the first material component undergoes softening.

According to a refinement of the invention, it is provided that the sintering temperature is chosen to be lower than the melting point of the first material component. The sintering temperature is preferably chosen to be at least 60% to at most 80% of the melting point of the first material component, preferably 80% of the melting point of the first material component. In particular a sintering process without a liquid phase takes place here, resulting in a bonding of the powder grains of the first material component here in particular due to volume diffusion, interfacial diffusion along the grain boundaries and/or crystal plastic flow. The molded body then undergoes some shrinkage, but there is preferably no change in its spatial geometric shape. The shrinkage corresponds in particular to a scaling of the dimensions of the molded body.

Since the second material component preferably has a higher melting point than the first material component, it is not softened and is not melted by sintering under the aforementioned conditions. The particles of the second material component, which are present in particular as powder grains are instead embedded in a cohesive matrix formed from the first material component by sintering.

According to a refinement of the invention, it is provided that the molded body extruded or cast from metal powder in particular is subjected to a binder removal step before sintering. In this way, the binder component, which essentially serves to better shape the mixture into a molded body, is removed prior to sintering. The binder removal step may involve in particular a catalytic, chemical or thermal binder removal. The binder removal step may also comprise a plurality of binder removal substeps, wherein various types of binder removal may be combined with one another, for example, a chemical binder removal in a first substep and a thermal binder removal in a second substep.

The shaping of the mixture is preferably accomplished by a powder metallurgical method.

According to a refinement of the invention, it is provided that the molding of the mixture takes place by pressing. In this case, the mixture is preferably in the form of pressed granules—in particular without a binder component—which are pressed into a mold, thereby producing the molded body. On the whole, press sintering is preferably accomplished together with the sintering step.

Alternatively, it is provided that the shaping of the mixture is carried out by extrusion. The mixture is then extruded in the form of a kneadable mass, preferably containing a binder component. The molded body is especially preferably produced by extrusion molding.

Alternatively, it is possible for the molding of the mixture—including a binder component in particular—to be carried out by means of powder injection molding. Metal powder injection molding (MIM) is especially preferred. With this procedure, it is possible to obtain even highly complex shapes in a simple manner.

It is also possible for the molding of the mixture to take place by means of a generative procedure. A layer buildup method is possible in particular. According to a preferred embodiment, the mixture is shaped by printing, in particular by means of a 2D or 3D printer.

It is possible in particular for the mixture to be printed by means of a 2D printer or a 3D printer on a substrate, to which the mixture is preferably not bonded. It is possible in particular to print in this way a greenware product, from which the binder is then removed, and which can then be sintered as a brownware product.

The metal powder particles of the second material component, which are preferably melted only at a higher temperature, are then embedded fixedly in the sintering matrix alloy of the first material component. In doing so, they enter into a material bond with the first material component on an atomic level, so that the powder particles of the second material component are permanently bonded mechanically to the resulting sintered component in a stable form.

According to a refinement of the invention, it is provided that the molded body is bonded to another molded body in a two-component injection molding method, wherein the additional molded body is free of the second material component. The molded body is especially preferably molded partially onto the additional molded body in the two-component injection molding method. Next, the molded body and the additional molded body are sintered jointly.

The fact that the additional molded body is free of the second material component preferably means that it does not contain any of the second material component. The additional molded body especially preferably contains only the first material component—plus optionally a binder component. It is then readily possible to produce even larger parts, for example, an electrode with a discharge component by means of the two-component injection molding method, and to do so less expensively, in which case only a part that is relevant for the discharge can be manufactured from the composite material, and other parts of the electrode can be manufactured from the inexpensive first material component without having to provide material for the second material component in doing so. In particular, a complex geometric shaping of larger one-piece elements, for example, electrodes, using the discharge component of the composite material is then possible.

Alternatively, it is also possible for the molded body to be bonded to an additional molded body produced separately, such that it is free of the second material component. Again in this case, the molded body and the additional molded body are preferably sintered together. However, in contrast with the procedure described previously, a two-component injection molding method is not used here, but instead an additional molded body is produced separately—for example, in a separate metal powder injection molding method or by pressing or extrusion—and then is joined to the molded body in a green state in particular. This may optionally be easier and less expensive than is the case with the two-component injection molding method.

More than two molded bodies may also be joined together.

In particular in a two-component injection molding method, it is possible to produce a greenware product in which the composite material is provided only in very specific locations, wherein a greenware product consisting of a plurality of molded bodies in this way—at least as an imaginary process—can be sintered together in a physically bonded manner in a downstream process without any joining operations. It is also possible to join greenware products of the composite material manufactured separately with those of the primary material, i.e., the first material component, and then to sinter these jointly in a physically bonded manner.

Because of the same thermal expansion coefficients of the first material component in the various molded bodies, composite substances fabricated in this way are definitely much more stable mechanically than those produced by traditional joining methods and therefore they have a longer lifetime.

The molded bodies can be produced in particular by similar methods or by different methods. For example, it is possible for one of the molded bodies to be produced by powder injection molding, while another one of the molded bodies is produced by pressing or extrusion.

According to a refinement of the invention, it is provided that the molded body is joined in a form-fitting and/or physically bonded manner to another body, in particular a base body for an electrode. It is possible in this way to easily, rapidly and inexpensively produce a component, in particular an electrode, having the composite material only in selected region.

It is possible in particular for a hybrid injection molding method to be used, wherein the molded body is integrally molded onto an insert, or wherein an insert is encased in the molded body. The insert is preferably not produced by sintering. It can preferably be produced by cutting, for example, as a lathed part. The molded body is preferably sintered in the presence of the insert. The insert preferably contains the first material component, which is also present in the molded body, or the insert consists of this first material component. This yields a particularly strong and permanent connection between the molded body and the insert.

Finally, this object is also achieved by creating a discharge component, comprising or consisting of the composite material according to any one of the exemplary embodiments described above. This yields in particular the advantages already explained in conjunction with the composite material and the method. The discharge component is preferably produced in one of the embodiments of the method as described previously.

An electrode array having at least two electrodes, at least one of the electrodes comprising a discharge component according to any one of the exemplary embodiments described above, is also preferred.

A base body of an electrode, comprising a discharge component with the composite material, preferably comprises the first material component as a material or consists of the first material component. In this case, it is particularly simple to physically bond the discharge component—in particular a component produced previously within the context of an embodiment of the method—to the base body of the electrode by welding, for example, because the matrix material of the composite material, namely the first material component, has the same or a similar thermal expansion coefficient and thus also has the same or similar material properties as the base body of the electrode. In particular, tried and tested standard welding methods may be used for joining the discharge component to the base body, for example, electric resistance welding and/or welding by Joulean heat alone.

It is therefore possible to arrange the discharge component with the composite material only locally on at least one electrode, which makes it possible to save on the use of expensive material.

However, it is also possible to produce the entire electrode or even an entire electrode array within the scope of the method described above, wherein a base body of the at least one electrode is preferably produced or supplied as an additional molded body, which is joined to the composite material for the discharge component in a green state —either by means of two-component injection molding or by means of separate production and joining in the green state.

In a preferred embodiment, the electrode array has at least two electrodes, namely in particular one electrode and one counter electrode, for example, an electrode which is acted upon by a potential that is different from zero, and a ground electrode, wherein it is provided that each one of the electrodes has a discharge component according to any one of the embodiments described previously, it preferably being provided that the discharge components of the at least two electrodes have a similar composite material, in particular the same composite material, or consist of a similar composite material, in particular the same composite material.

The description of the composite material and of the discharge component and also the description of the electrode array, on the one hand, and of the method, on the other hand, are to be understood as complementary to one another. Features of the composite material, of the discharge component or of the electrode array, which have been described explicitly or implicitly in conjunction with the method, are preferably individual features of a preferred embodiment of the composite material, of the discharge component or of the electrode array or features that have been combined with one another. Method steps, which have been described explicitly or implicitly in conjunction with the composite material, the discharge component or the electrode array, are preferably individual or combined steps of a preferred embodiment of the method. This is preferably characterized by at least one method step, which is determined by at least one feature of an inventive or preferred embodiment of the composite material, of the discharge component and/or of the electrode array. The composite material, the discharge component and/or the electrode array is/are preferably characterized by at least one feature, which is determined by at least one step of an inventive or preferred embodiment of the method.

The invention is explained in greater detail below on the basis of the drawing, in which:

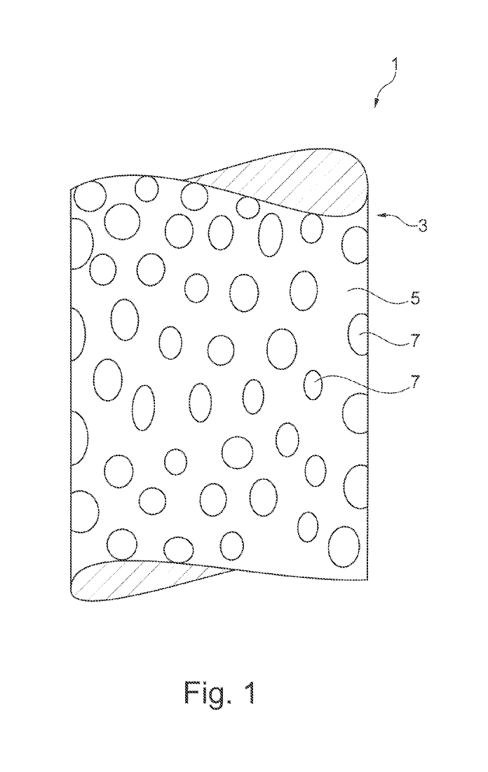

FIG. 1 shows a schematic diagram of an embodiment of a discharge component with an embodiment of the composite material, and

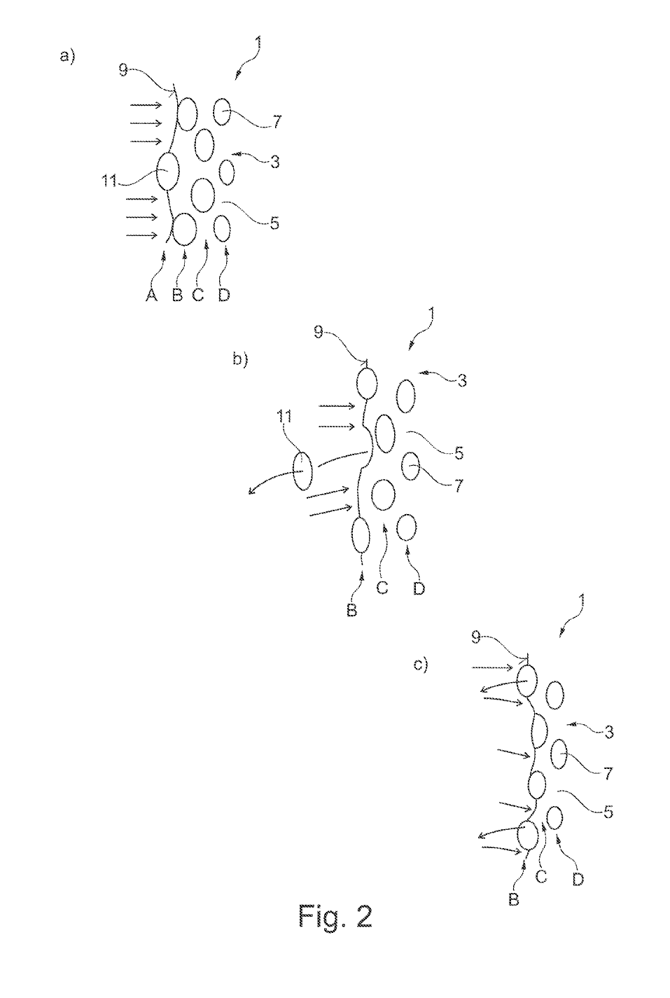

FIG. 2 shows a schematic diagram of the functioning of the discharge component according to FIG. 1.

FIG. 1 shows a schematic diagram of one embodiment of a discharge component 1 consisting of an embodiment of a composite material 3. This composite material comprises a first metallic material component 5 and a second metallic material component 7, wherein the first material component 5 and the second material component 7 are different from one another, and wherein the first material component 5 here has a lower melting point than the second material component 7. The second material component 7 here is incorporated into the first material component 5 in particulate form. For the sake of better comprehensibility, only two particles of the second material component 7 are labeled with the reference numeral 7 here.

The first material component 5 in the exemplary embodiment illustrated here has a cohesive matrix, in which the second material component 7 is embedded in the form of the particles illustrated in FIG. 1. It can be seen here that the second material component 7 is incorporated discontinuously, i.e., in particular in the form of separate particles into the first material component 5 here.

The second material component 7 is preferably more noble than the first material component 5, which means in particular that the second material component 7 has a higher standard potential than the first material component 5. The second material component 7 in particular has a standard potential higher than zero. The first material component 5 preferably also has a standard potential higher than zero. However, it is also possible for the first material component 5 to have a negative standard potential.

The first material component 5 preferably has a nickel-based alloy or a malleable iron alloy, in particular a steel, preferably a stainless steel, or consists of one of these materials. It is preferably provided that the first material component 5 comprises nickel and chromium, wherein nickel preferably forms a main constituent of the first material component 5, and wherein chromium preferably forms one of the most important secondary constituents, in particular in the sense of a greatest amount by weight, based on all the secondary components.

The second material component 7 preferably comprises at least one element, selected from a group consisting of iridium, platinum, rhodium, ruthenium, palladium and a rare earth metal. It is possible for the second material component 7 to consist of one of the aforementioned elements. The second material component 7 preferably comprises an alloy or a combination of at least two of these elements, in particular an alloy comprising platinum and iridium or iridium and rhodium, preferably platinum-iridium or iridium-rhodium, or the second material component 7 consists of such a combination or alloy.

A portion of the second material component 7 of the composite material 3 preferably amounts to—in percent by weight—at most 80, preferably at most 70, preferably at most 60, preferably at most 50, preferably at most 40, preferably at most 30, preferably at most 20, preferably at most 10.

The second material component 7 is preferably in the form of particles having a particle size of at least 5 μm to at most 100 μm.

The composite material 3 is preferably produced by mixing the first metallic material component 5 in powder form with the second metallic material component 7, which is also in powder form. A binder component is preferably mixed with the first material component 5, with the second material component 7 and/or with the mixture of material components 5, 7. On the whole, this yields a mixture which ultimately comprises the first material component 5, the second material component 7 and preferably the binder component. This mixture is shaped to form a molded body, which is then sintered at a sintering temperature lower than the melting point of the second material component 7, preferably lower than the melting point of the first material component 5 and especially preferably from at least 0.6 to at most 0.8 multiplied times the melting point of the first material component, preferably 0.8 multiplied times the melting point of the first material component.

A homogenous mixture of the material components 5, 7 is preferably prepared, wherein the particles of the second material component 7 in particular are arranged individually between particles of the first material component 5. Sintering therefore results in a cohesive matrix of the first material component 5, in which the particles of the second material component 7 are embedded separately, in particular not cohesively.

Shaping of the mixture to form the molded body preferably takes place by pressing, extruding or powder injection molding, in particular by means of metal powder injection molding.

A molded body produced in particular by extrusion or injection of powder is preferably subjected to a binder removal step before sintering, this step optionally comprising a plurality of binder removal substeps.

It is possible for the molded body to be attached to another molded body, in particular another greenware body, in particular being integrally molded on the additional molded body, wherein the initial molded body is free of the second material component 7 and preferably comprises only the first material component 5 and optionally a binder component. A larger component can be created in one piece in this way, comprising the discharge component made of the composite material 3. For example, an electrode comprising the discharge component 1 made of the composite material 3 only in a certain region or in various certain regions can be created.

This can also be achieved by attaching the molded body in a green state, i.e., as greenware or as a greenware product, to another molded body produced separately, preferably in the form of a greenware or a greenware body, wherein the additional molded body in this case is also free of the second material component 7 and preferably comprises only the first material component 5 and preferably also a binder component. The two molded bodies in this case may also be sintered jointly.

The two molded bodies can be produced in particular in similar methods or in different methods. For example, it is possible for one of the molded bodies to be produced by powder injection molding, wherein the other molded body is produced by pressing or extrusion.

It is also possible to use a hybrid injection molding method, wherein the molded body is integrally molded on an insert, or wherein an insert is encased in the molded body. The insert can be produced by cutting by machining, for example, as a lathed part. The molded body is preferably sintered in the presence of the insert.

FIG. 2 shows a schematic diagram of the functioning of the discharge component 1 with the composite material 3. The same elements and those having the same function are labeled with the same reference numerals, so that reference is made to the preceding description to this extent.

FIG. 2 shows in particular arrows pointing to a surface 9, such as a discharge having a negative effect on the surface 9 of the discharge component, wherein the discharge leads in particular to erosion and/or corrosion of the discharge component 1 in the area of the surface 9. As already indicated schematically, this leads first to a burnoff of matrix material, and consequently of the first material component 5. Therefore, particles of the second material component 7 are exposed, so that four rows of particles A, B, C, D are represented schematically in FIG. 2a)—as seen in the radial direction from the surface 9 perpendicular to interior of the discharge component. A particle 11 in the first particle row A is already partially exposed due to erosion and/or corrosion of the surface 9.

FIG. 2b) shows that, with additional application of discharges to the discharge component 1 and continued erosion and corrosion, the particle 11 is at some point released from the matrix composite of the first matrix material 5 and falls out of the surface 9—as indicated by an arrow and a dash. Due to the advanced burnoff of the surface 9, the outermost row A of particles is thus released, and the second row B of particles arranged behind the former advances more or less after it and becomes the new first row of particles. Burnoff occurs essentially in the region of the less noble first material component 5, which has a lower melting point.

FIG. 2c) therefore shows that, after a certain additional application in the area where the particle 11 had previously been arranged, so much material of the first material component 5 has now burned off that additional particles from the third row C of particles have been exposed. These particles, which are more or less pushed forward, then take over the function of the particle 11 released from the surface.

It is found that with composite material 3, it is possible to provide a greater area with locally reduced wear at the same cost of materials for a discharge as if only the second material component 7 had been exposed in the area that is effective for the discharge.

The ignition energy that must be expended to form the discharge can be concentrated in small areas, in particular those of the particles of the second material component 7, so that it is possible to work with comparatively low ignition voltages. This then further reduces the wear on the discharge component.

In addition, it is found that typically only a certain wear in the form of a radial burnoff zone of typically approx. 200 μm is acceptable for discharge components, after which the discharge component 1 or even the entire electrode must be replaced. It is now possible to use the composite material 3 over only this so-called burnoff zone as the discharge component on an electrode and to form a remaining greenware product of the electrode from an inexpensive material, for example, from the first material component 5. After burnoff of the discharge component is finished, there remains only the inexpensive first material component 5 for disposal, so that a corresponding electrode with a discharge component 1 is considerably less expensive than an electrode that comprises, on the whole, an expensive material that is also more stable.

1. A composite material, comprising
a first metallic material component, and
a second metallic material component, wherein
wherein the first metallic material component is different from the second metallic material component, and further wherein the second material component is mixed with the first metallic material component.

2. The composite material according to claim 1,
wherein
a) the first material component forms a cohesive matrix, into which the second material component is incorporated in particulate form, and/or in that
b) the second material component is incorporated discontinuously, in the form of separate particles, into the first material component, and/or
c) the second material component is incorporated into the first material component in the form of particles with a particle size of at least 5 μm to at most 100 μm, preferably up to at most 70 μm, preferably up to at most 50 μm.

3. The composite material according to
claim 1, wherein:
a) the first material component has a lower melting point than the second material component, and/or
b) the second material component is more noble than the first material component.

4. The composite material according to
claim 1, wherein the first material component comprises:
a) a nickel-based alloy or a malleable iron alloy or consists of a nickel-based alloy or a malleable iron alloy, and/or
b) nickel and chromium.

5. The composite material according to claim 1, wherein the second metallic material component comprises an element selected from a group consisting of iridium, platinum, rhodium, ruthenium, palladium and a rare earth metal, or in that the second metallic material component consists of one of these elements.

6. The composite material according to claim 1, wherein
a) a portion of the second metallic material component of the composite material—in percent by weight—amounts to at most 80 or
b) in that a volume ratio of the second material component to the first material component amounts to at least 10:90 to at most 90:10.

7. A method for producing a composite material, the method comprising
mixing a first powdered metallic material component with a second powdered metallic material component, wherein the first material component is different from the second metallic material component, and wherein the first metallic material component has a lower melting point and/or is less noble than the second material component;
preparing a mixture, comprising the first material component and the second metallic material component;
shaping the mixture into a molded body; and
sintering the molded body, at a sintering temperature lower than the melting point of the second material component.

8. The method according to claim 7, further comprising:
mixing a binder component with the first metallic material component and/or with the second metallic material component,
wherein the resulting mixture comprises the first metallic material component, the second metallic material component and the binder component.

9. The method according to claim 7, wherein the sintering temperature is selected to be lower than the melting point of the first metallic material component.

10. The method according to claim 8, further comprising subjecting the molded body to a binder removal step before sintering.

11. The method according to claim 7, wherein the shaping of the mixture is carried out by a powder metallurgy method.

12. The method according to claim 7, wherein the shaping of the mixture is carried out by pressing.

13. The method according to claim 7, wherein the molded body;
a) is joined to another molded body in a two-component injection molding method,
wherein the additional molded body is free of the second metallic material component, or
b) is joined to another molded body produced separately, said the molded body being free of the second material component,
wherein the molding body and the additional molded body are sintered jointly.

14. The method according to claim 7, wherein the molded body is joined to an additional body in the form of a base body for an electrode in at least one of a form-fitting connection and a physically bonded connection.

15. A discharge component, comprising a composite material according to claim 1 or consisting of the composite material.
